(19) United States
(12) Patent Application Publication
(10) Pub. No.: US 2015/0027028 A1
(43) Pub. Date: Jan. 29, 2015

(54) DECOY ATTACHMENT DEVICES AND ASSEMBLIES

(71) Applicant: Adam Steinberg, Blooming Prairie, MN (US)

(72) Inventor: Adam Steinberg, Blooming Prairie, MN (US)

(21) Appl. No.: 13/950,949

(22) Filed: Jul. 25, 2013

(51) Int. Cl. A01M 31/06

(52) U.S. Cl. CPC A01M 31/06
USPC 43/2

(57) ABSTRACT

Decoy attachment devices for attaching hunting decoys to cover structures, such as layout blinds or ghillie blankets, are provided. The decoy attachment devices can be permanently attached to a hunting cover structure, or designed to be removeably secured to one or more straps, such as stubble straps, on the cover structure. Also provided are decoy assemblies that include a cover structure, a decoy attachment device and an attached decoy.

### BACKGROUND

Using decoys to help hide hunting blinds isn't a new tactic, but oftentimes hunters actually accentuate their layout blind placement without knowing it. Placing decoys closely around a blind helps, but this approach can leave blinds framed or outlined, making them even more visible to vertically decoying waterfowl.

Using decoys on taller than normal stakes or flyers around a blind are also popular tactics. However, if one looks at the spread from an overhead point of view, one can quickly discern that this actually draws more attention to the area in which the blind is located. An oversized shell decoy strapped to the blind doors or foot bag does the same thing—drawing more attention to being different than concealing the blind. Finally, a deflated crumbled-up windsock zip-tied to a stubble strap doesn't look like a bird and fails to provide adequate coverage.

Any difference between the surroundings and a spread that birds can focus on is bad. The spread should uniformly blend into the surroundings.

### SUMMARY

Decoy attachment devices, decoy assemblies incorporating the decoy attachment devices and methods for using the decoy attachment devices are provided. The decoy assemblies provide an enhanced level of hunting blind or ghillie blanket concealment.

One embodiment of a decoy attachment device comprises a base configured to secure to at least one strap, such as a stubble strap, on a hunting blind or ghillie blanket and a decoy holder attached to the base and configured to secure a decoy to the decoy attachment device. The decoy attachment devices are well-suited for use with waterfowl hunting blinds and waterfowl decoys. Examples of suitable hunting blinds include layout blinds, pit blinds, water blinds, boat blinds and dog blinds.

In some embodiments, the base of the device comprises a plate and the decoy holder is configured to be attached to the plate in two or more different fixed rotational orientations.

In some embodiments, the base of the device comprises a plate and the decoy holder is configured to secure a decoy in two or more different fixed angular orientations with respect to the base. Such configurations can be provided, for example, by decoy holders comprising a convex arcuate track having two or more decoy securement locations along the track, or by decoy holders comprising a joint configured such that it can pivot vertically with respect to the plate.

One embodiment of a decoy assembly comprises: a hunting blind or ghillie blanket; a decoy attachment device, as described herein, comprising a base secured to the hunting blind or ghillie blanket and a decoy holder attached to the base; and a decoy secured to the decoy holder. In some embodiments of the decoy assemblies, the base is permanently secured to the hunting blind or ghillie blanket. In other embodiments, the base is removably secured to the hunting blind or ghillie blanket. For example, the base can be removeably secured to a strap on a layout blind or ghillie blanket.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 is a perspective view of one embodiment of a decoy attachment device.

FIG. 2 is a perspective view of another embodiment of a decoy attachment device.

FIGS. 3A, 3B and 3C show a top view, a perspective view and a side view, respectively, of a decoy attachment device comprising a decoy holder with an adjustable clasp. FIG. 3D shows an enlarged perspective view of the decoy holder.

FIGS. 4A, 4B and 4C show a top view, a perspective view and a side view, respectively, of a decoy attachment device comprising a decoy holder with a hitch pin.

FIGS. 5A, 5B and 5C show a top view, a perspective view and a side view, respectively, of a decoy attachment device having a peripheral edge that defines a plurality of prongs.

FIGS. 6A, 6B and 6C show a top view, a perspective view and a side view, respectively, of a decoy attachment device comprising a plurality of through holes.

FIGS. 7A, 7B and 7C show a top view, a perspective view and a side view, respectively, of a decoy attachment device comprising a decoy holder with a joint configured to pivot vertically. FIG. 7D shows a detailed perspective view of the decoy holder.

FIGS. 8A, 8B and 8C show a top view, a perspective view and a side view, respectively, of a decoy attachment device comprising a plurality of decoy holders. FIG. 8D shows a detailed perspective view of one of the decoy holders.

FIGS. 9A, 9B, 9C and 9D show a bottom view, a side view, a front view and a perspective view, respectively, of a part of a decoy holder configured to secure a decoy at different fixed angular orientations.

FIG. 10 shows an example of a base configured to engage with the decoy holder of FIG. 9. FIGS. 10A and 10B show a top view and a perspective view of the base, respectively. FIG. 10C shows a perspective view of the base with the decoy holder of FIG. 9 attached.

FIG. 11 shows a decoy assembly that includes a decoy attachment device of the type shown in FIG. 1.

### DETAILED DESCRIPTION

Decoy attachment devices for attaching hunting decoys to cover structures, such as hunting blinds or ghillie blankets, are provided. In some embodiments, the decoy attachment devices are designed to secure to one or more straps, such as stubble straps, on the cover structure.

Also provided are decoy assemblies that include a cover structure, a decoy attachment device and an attached decoy. In some embodiments the decoy attachment devices are permanently attached to a cover structure, while in other embodiments, they are removably attached. For the purposes of this disclosure, a decoy attachment device is considered permanently attached if it is not readily removable and re-attachable in the same manner by a hunter in the field. A permanent attachment may be provided at the place of manufacture. For example, a decoy assembly can be fabricated with a permanent attachment at the factory by sewing, riveting, stapling, welding or gluing the device to the cover structure. A removable attachment is a temporary attachment that can be readily severed and then reattached in the same manner by a hunter in the field. Thus, a removeable attachment makes it possible to purchase and/or store the decoy attachment device and the hunting blind or cover structure separately. A removeable attachment may be provided between the device and the cover structure, for example, using hooks, prongs, clips, pins, ties, straps and the like. In some embodiments, the removeable attachment is configured such that the attachment can be readily severed by hand, without the use of any tools.

Windsock-type decoys are an example of a type of decoy that can be secured by the attachment devices. Such decoys comprise an air bladder designed to imitate the general appearance of a one's prey, typically some type of bird, and a stake attached to air bladder. The stake generally comprises a rod-like shape and provides a spacing between the air bladder and the cover structure so that the air bladder can freely inflate and move in a breeze. Full body-type decoys and silhouette decoys are other examples of decoys that can be secured using the decoy attachments devices. Each of these types of decoys may include a stake to which the decoy attachment device can be secured. However, the stakes are not necessary, as the decoy attachment devices can be configured to secure directly to the main body of the decoy.

A basic embodiment of the decoy attachment devices comprises a base configured to secure to at least one strap on a hunting blind or a ghillie blanket and a decoy holder that is attached to the base and configured to secure a decoy.

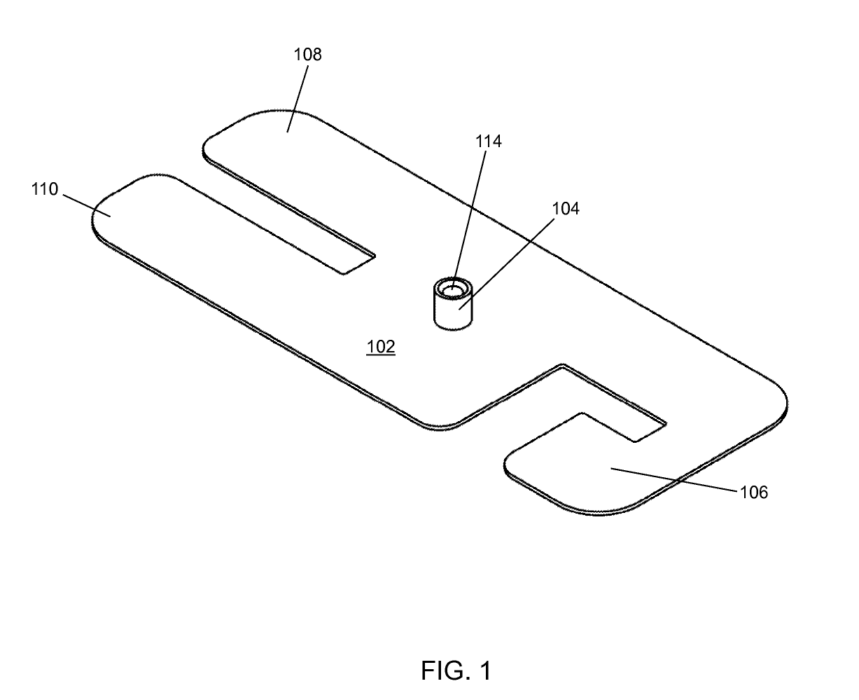

One specific embodiment of a decoy attachment device is illustrated in FIG. 1. This device comprises a base comprising a plate 102 and a decoy holder comprising an attachment port 104. One end of plate 102 comprises a hook 106 that is configured to hook around a strap, such as a stubble strap, on a layout blind or ghillie blanket, thereby securing the base to said strap. Another end—in this case, the opposite end—of plate 102 comprises a first prong 108 and a second prong 110 running substantially parallel with first prong 108. First and second prongs 108, 110 are configured to extend under neighboring straps, such as stubble straps, on a layout blind or ghillie blanket, thereby securing the base to said straps. Attachment port 104 defines an opening 114 into which the stake of a decoy, such as a windsock-type decoy, can be inserted, thereby securing the decoy to the decoy attachment device via the decoy holder. Opening 114 may be, for example, a threaded hole into which a threaded decoy stake may be screwed.

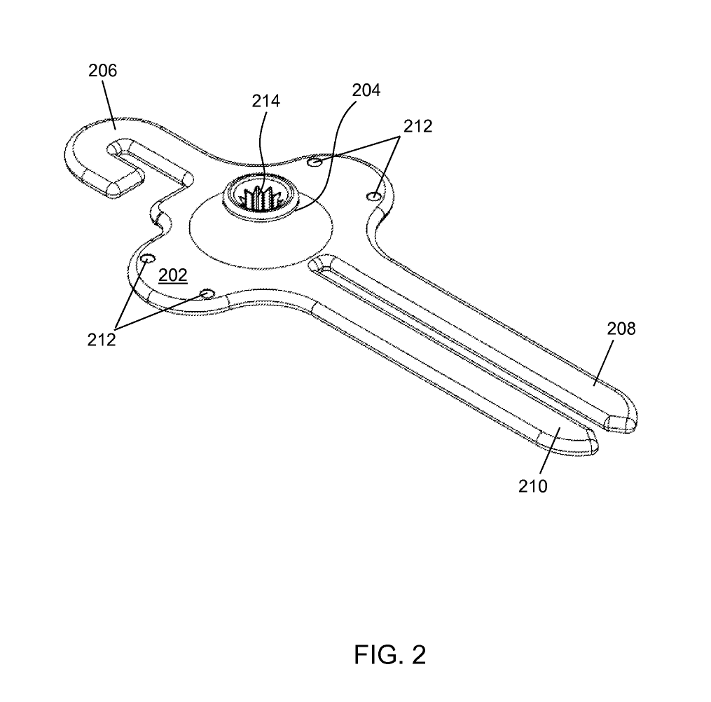

A similar embodiment of a decoy attachment device is illustrated in FIG. 2. As in the embodiment of FIG. 1, the base comprises a plate 202 and the decoy holder comprises an attachment port 204. In this embodiment, attachment port 204 is configured to secure a decoy in two or more fixed rotational orientations with respect to plate 202, as discussed in greater detail below. One end of plate 202 comprises a hook 206 that is configured to hook around a strap on a layout blind or ghillie blanket, thereby securing the base to said strap. Another end—in this case, the opposite end—of plate 202 comprises a first prong 208 and a second prong 210 running substantially parallel with first prong 208. First and second prongs 208, 210 are configured to extend under neighboring straps on a layout blind or ghillie blanket, thereby securing the base to said straps. In addition, plate 202 defines holes 212 through which pins, screws or the like may be inserted to provide for a more rigid, yet still detachable, securement of the base to a cover structure. Here again, attachment port 204 defines an opening 214 into which the stake of a decoy can be inserted, thereby securing the decoy to the decoy attachment device via the decoy holder.

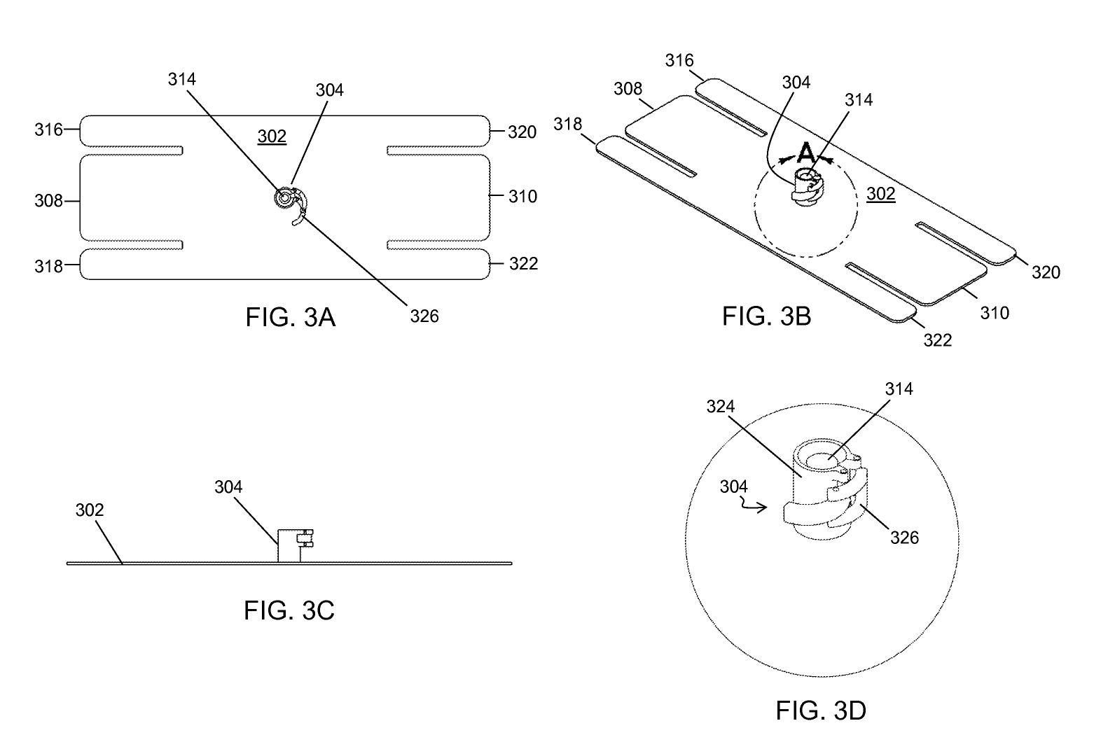

Another embodiment of a decoy attachment device is illustrated in FIGS. 3A-3D. FIGS. 3A, 3B and 3C show a top view, a perspective view and a side view, respectively, of the device. FIG. 3D shows a detailed perspective view of the decoy holder. In this embodiment, the base comprises a plate 302 and the decoy holder comprises an attachment port 304 defining an opening 314 into which the stake of a decoy can be inserted. One end of plate 302 comprises a first central prong 308 flanked by a first pair of side prongs 316, 318. Another end of plate 302 comprises a second central prong 310 flanked by a second pair of side prongs 320, 322. Central prongs 308, 310 and side prongs 316, 318, 320 and 322 are configured such that any or all of them extend under a strap on a layout blind or ghillie blanket, thereby securing the base to said straps. Attachment port 304 comprises a compressible and re-expandable ring-shaped wall 324 and an adjustable clasp 326. Adjustable clasp 326 allows the user to change the setting of the decoy holder from an open position (shown in FIG. 3A), in which opening 314 has a first diameter that allows for easy insertion of a decoy stake, to a closed position (shown in FIGS. 3B and 3D), in which opening 314 has a second, smaller diameter that provides for a tight fit around a decoy stake.

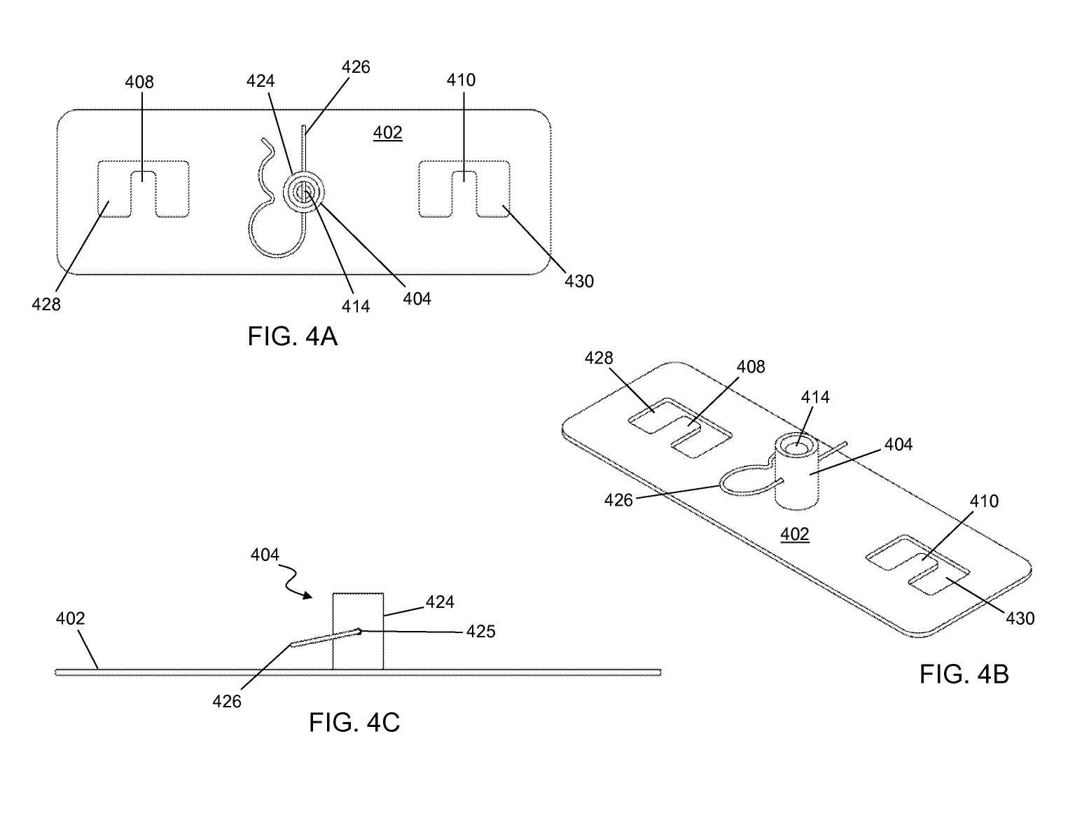

Another embodiment of a decoy attachment device is illustrated in FIGS. 4A-4C. FIGS. 4A, 4B and 4C show a top view, a perspective view and a side view, respectively, of the device. In this embodiment, the base comprises a plate 402 and the decoy holder comprises an attachment port 404 defining an opening 414 into which the stake of a decoy can be inserted. Plate 402 comprises a first prong 408 and a second prong 410 disposed on opposite sides of attachment port 404. First and second prongs 408 and 410 are configured to extend under a first strap and a second strap, respectively, of a hunting blind or a ghillie blanket, thereby securing the base to said straps. Unlike the prongs depicted in FIGS. 1-3, which are defined in the peripheral edge of a base plate, prongs 408 and 410 are defined by internal edges of the plate 402 formed by a first opening 428 and a second opening 430. Attachment port 404 comprises a ring-shaped wall 424 comprising two aligned pin holes 425 (only one pin hole is visible in the figure), and further comprises a hitch pin clip 426 configured to extend through aligned pin holes 425. This decoy holder design is configured for use with a decoy stake having a transverse pin hole configured to align with pin holes 425 of the decoy holder when the decoy is in place. Once the pin holes in the decoy holder and the decoy stake have been aligned, hitch pin clip 426 can be inserted through wall 424 and the decoy stake, thereby securing the decoy to the decoy attachment device. Although a hitch pin in used in this illustrative example, other types of pins, such as lynch pins, could be used. Alternatively, pin holes 425 could be threaded, such that they are configured to engage with a threaded screw for securing a decoy.

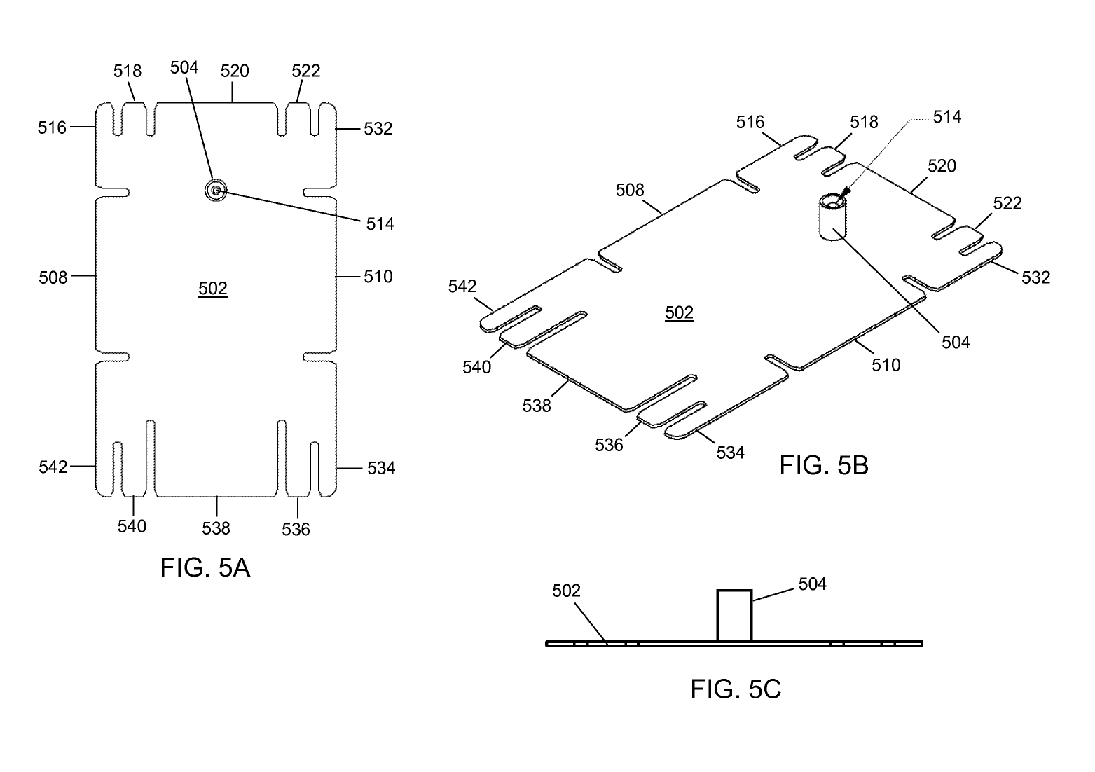

Another embodiment of a decoy attachment device is illustrated in FIGS. 5A-5C. FIGS. 5A, 5B and 5C show a top view, a perspective view and a side view, respectively, of the device. In this embodiment, the base comprises a plate 502 and the decoy holder comprises an attachment port 504 defining a central opening 514, of the type previously depicted in FIG. 1. The peripheral edge of plate 502 defines a plurality of prongs 508, 510, 516, 518, 520, 522, 532, 534, 536, 538, 540 and 542 configured such that any or all of them can extend under a strap on a hunting blind or ghillie blanket, thereby securing the base to said straps.

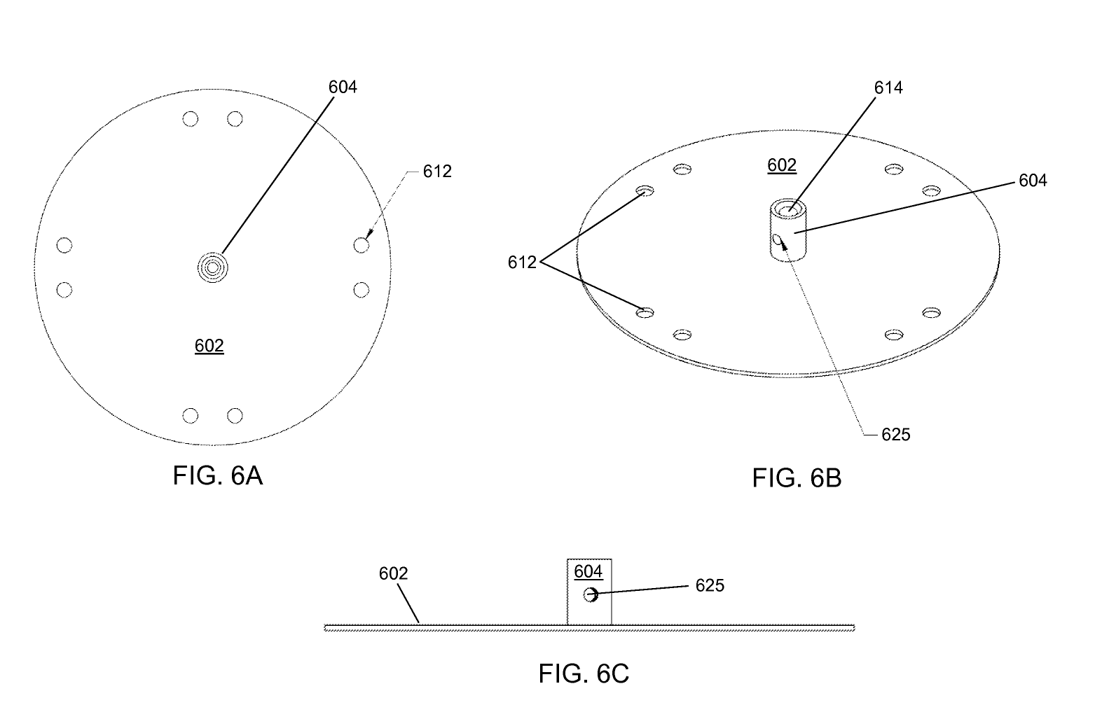

Another embodiment of a decoy attachment device is illustrated in FIGS. 6A-6C. FIGS. 6A, 6B and 6C show a top view, a perspective view and a side view, respectively, of the device. In this embodiment, the base comprises a plate 602 having a circular perimeter and the decoy holder comprises an attachment port 604 defining a central opening 614 and side wall pin holes 625, of the type previously depicted in FIG. 4. Plate 602 defines a plurality of holes 612 through which pins, screws or the like may be inserted to provide for a rigid, yet still detachable, securement of the base to a cover structure. For example, holes 612 may be positioned such that they are located over the stubble straps on a layout blind or a ghillie blanket when the base is in place, so that pins or screws inserted through the holes can be secured to the straps.

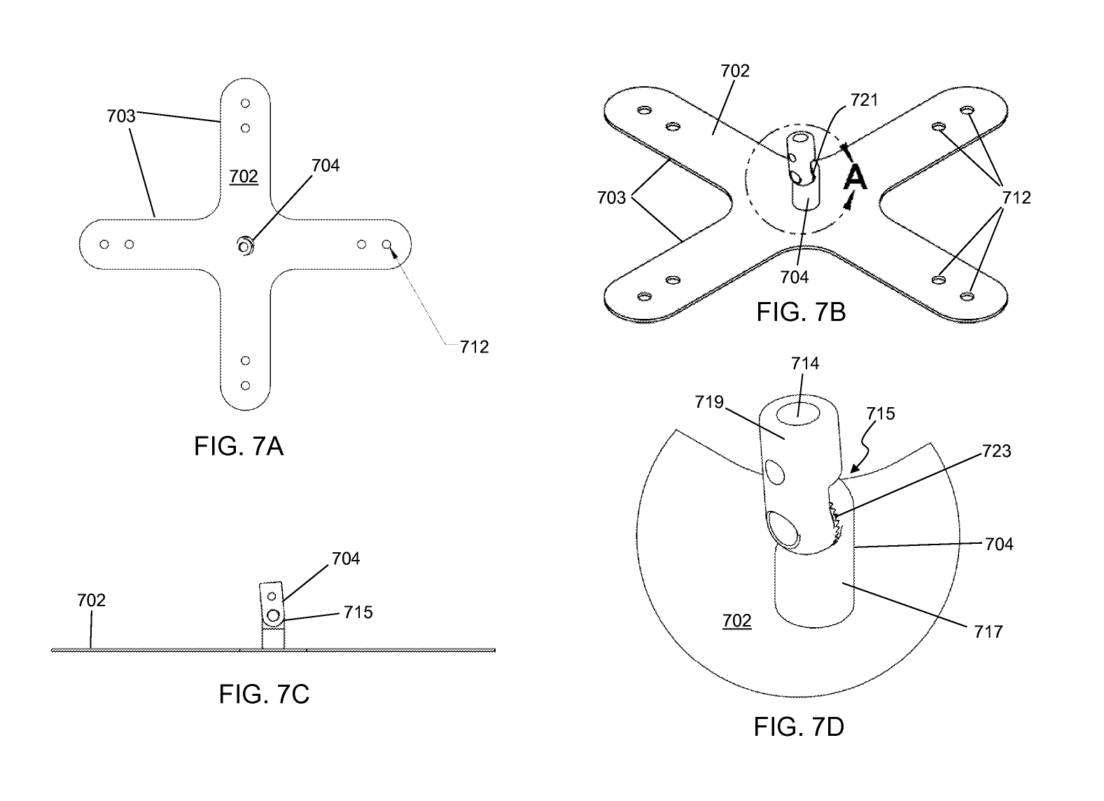

Another embodiment of a decoy attachment device is illustrated in FIGS. 7A-7D. FIGS. 7A, 7B and 7C show a top view, a perspective view and a side view, respectively, of the device. FIG. 7D shows a detailed perspective view of the decoy holder. In this embodiment, the base comprises a plate 702 having a cross-shaped perimeter comprising a plurality (e.g., four) radial extensions 703 extending outwardly from the center of the plate. These extensions can be used to facilitate the permanent attachment of the plate to a cover structure by, for example, sewing the extensions to the structure. Plate 702 defines a plurality of holes 712 through which pins, screws or the like may be inserted to provide for a rigid, yet still detachable, securement of the base to a cover structure. For example, holes 712 may be positioned such that they are located over the stubble straps on a hunting blind or a ghillie blanket when the base is in place, so that pins or screws inserted through the holes can be secured to the straps. The decoy holder comprises an attachment port 704. In this embodiment, attachment port 704 comprises a joint 715 configured to pivot vertically to allow for the adjustment of the spacing between the base and a secured decoy, as discussed in greater detail below.

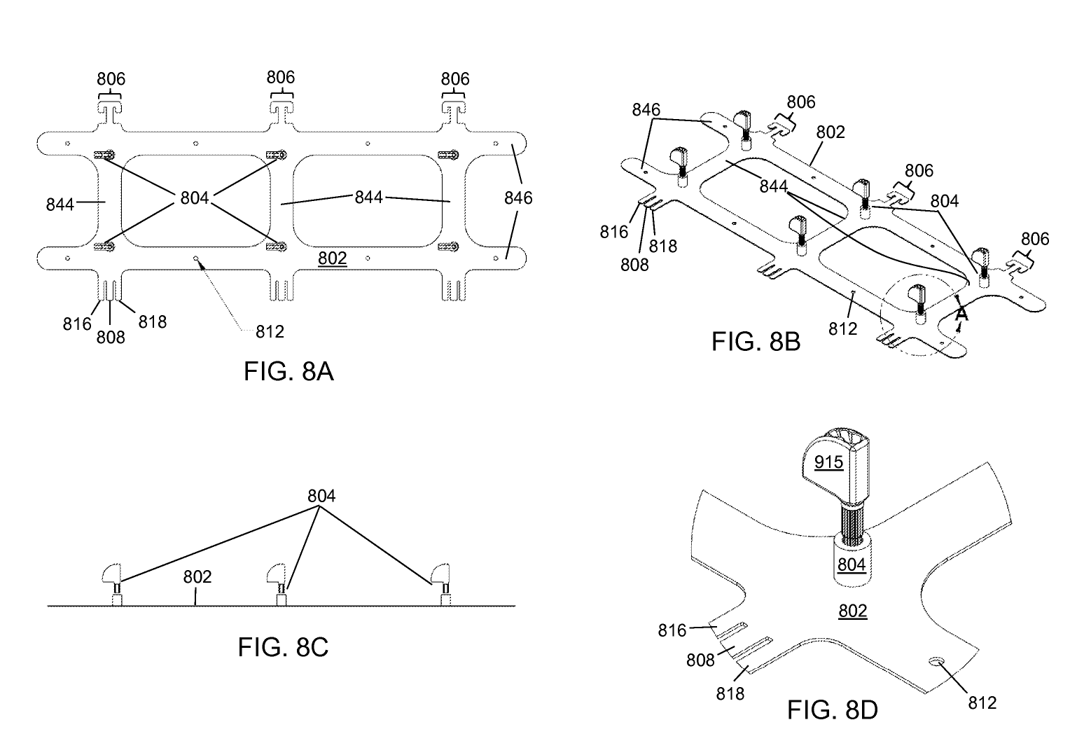

An embodiment of a decoy attachment device having a plurality of decoy holders is illustrated in FIGS. 8A-8D. FIGS. 8A, 8B and 8C show a top view, a perspective view and a side view, respectively, of the device. FIG. 8D shows a detailed perspective view of the decoy holder. In this embodiment, the base comprises a plate 802 in the shape of a grid comprising a plurality (e.g., three) of longitudinal slats 844 and a plurality (e.g., two) of transverse slats 846 running perpendicular to, or substantially perpendicular to, longitudinal slats 844. Decoy holders 804 are located at the intersections between longitudinal slats 844 and transverse slats 846. A pair of hooks 806 configured to hook around straps, such as stubble straps, on a layout blind or ghillie blanket, thereby securing the base to said straps, is located at one end of each longitudinal slat 844. The other end of each longitudinal slat 844 comprises a central prong 808 flanked by a pair of side prongs 816, 818. Central prong 808 and side prongs 816 and 818 are configured such that any or all of them extend under a strap on a hunting blind or ghillie blanket, thereby securing the base to said straps. The base further comprises a plurality of holes 812 through which pins, screws or the like may be inserted to provide for a rigid, yet still detachable, securement of the base to a cover structure.

The decoy holders of the present devices come in a variety of designs and may be configured to secure a decoy in a variety of positions and orientations with respect to the base. In some embodiments the decoy holders are rotatably attached to the base. That is, the decoy holders are mounted to the base in such a manner that the holder and the secured decoy rotate about a central axis. In other embodiments, the decoy holders are configured to secure a decoy in two or more different locations on the decoy holder. For example, the decoy holders may be configured to secure a decoy in two or more fixed angular orientations with respect to the base. One embodiment of such a decoy holder is depicted in FIG. 7C. As discussed previously, this decoy holder comprises attachment port 704 having a joint 715 configured to pivot vertically. That is, in a plane perpendicular to, or substantially perpendicular to, the plane of plate 702. Joint 715 comprises lower portion 717 and upper portion 719 which contact at interface 721. The surfaces of lower portion 717 and 719 which form interface 721 each define a plurality of teeth 723. The teeth of lower portion 717 are configured to engage with the teeth of upper portion 719, such that when a decoy has been secured by the decoy holder its angular orientation (as defined, for example, by the angle between the plane of plate 702 and longitudinal axis of a secured decoy shaft) with respect to the base is fixed. That is, the decoy holder is not free to pivot. However, the angular orientation of the decoy with respect to the base can be adjusted by disengaging the teeth of lower and upper portions 717 and 719, rotating upper portion 719 with respect to lower portion 717 and re-engaging the teeth of lower and upper portions 717 and 719.

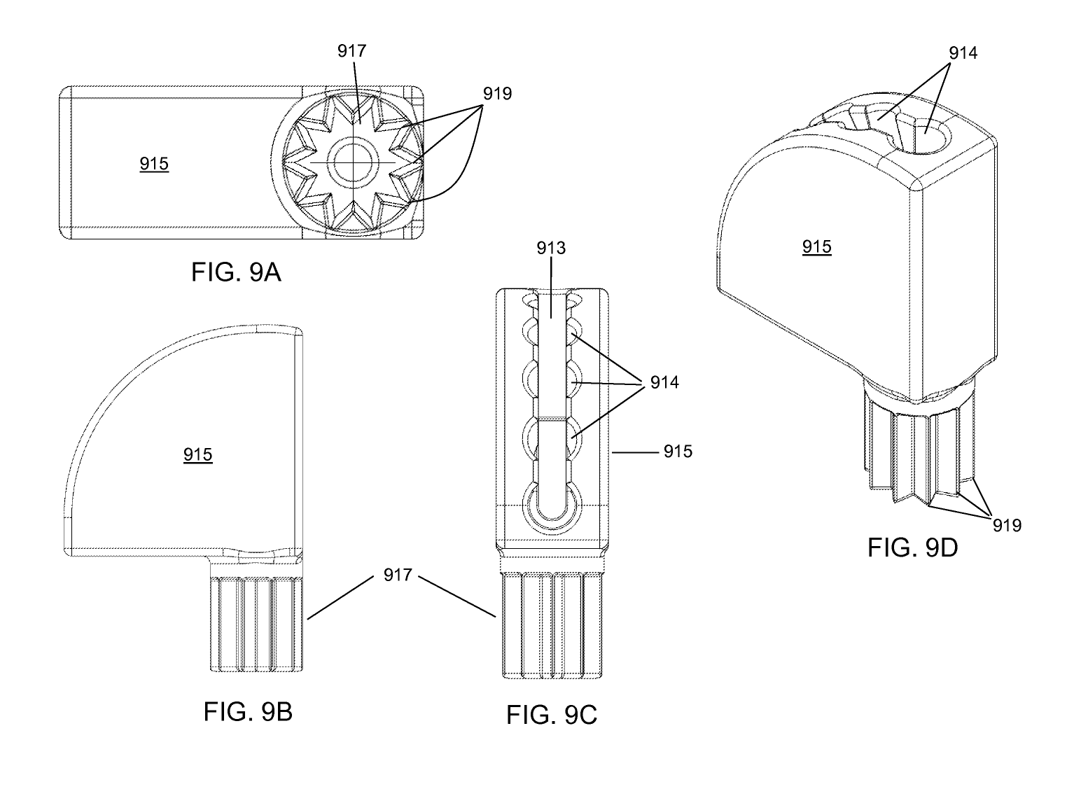

In an alternative design, the decoy holder may define two or more attachment ports, each configured to secure a decoy at a different angular orientation on the holder. An example of such an embodiment is shown in FIG. 9. FIGS. 9A, 9B, 9C and 9D show a bottom view, a side view, a front view and a perspective view, respectively, of the decoy holder. The decoy holder comprises a track 913 along which a plurality of attachment ports 914 in the form of openings are disposed. Openings 914 are configured to engage with a decoy stake. In this embodiment, track 913 is a convex arcuate track defined in a body 915 of the decoy holder.

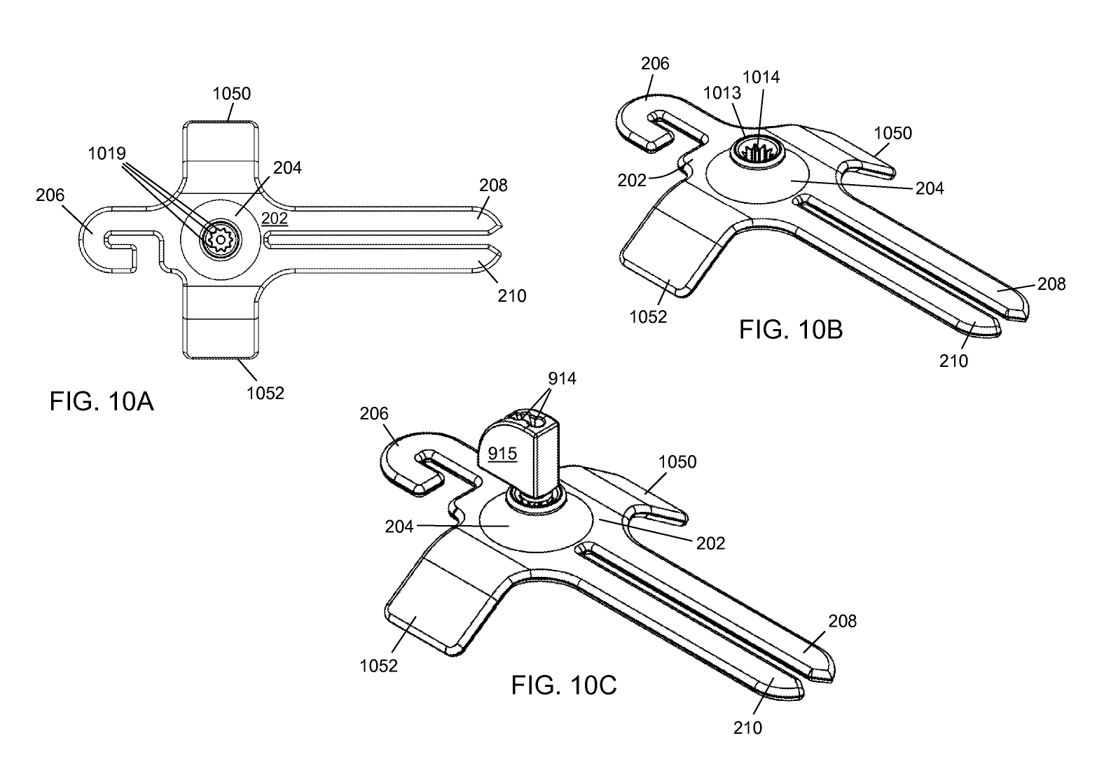

The decoy holders may also be configured to be attached to the base in two or more different fixed rotational orientations. For example, the decoy holder of FIG. 9 comprises a shaft 917. A plurality of radial extensions 919 run longitudinally along shaft 917 to provide shaft 917 with a star-shaped circumference. Radial extensions 917 are configured to engage with corresponding indentations in an engagement port attached to a base, as described below with reference to FIG. 10.

An example of a base configured to engage with shaft 917 is shown in FIG. 10. FIGS. 10A and 10B show a top view and a perspective view of the base, respectively. FIG. 10C shows a perspective view of the base and decoy holder with the body 915 of the decoy holder of FIG. 9 attached. The basic shape of the base in FIG. 10 is the same as that shown in FIG. 2 and, therefore, like elements are denoted with like reference numbers. However, the base in FIG. 10 differs in that it includes a pair of projections 1050, 1052 disposed on opposite sides of base plate 202. As shown in the perspective view of FIG. 10B, projections 1050 and 1052 extend downwardly such that they are not in the same plane as the rest of the base plate 202. This may be advantageous for securing a windsock-type decoy such that it is positioned above the stubble strap to which it is secured, so that it can freely fill, turn and move in the breeze. Attachment port 204 comprises a cylindrical wall 1013 that defines an opening 1014. The internal circumference of cylindrical wall 1013 comprises a plurality of indentations 1019 running longitudinally down the wall. Indentations 1019 provide opening 1014 with a star-shaped circumference that is configured to engage with the star-shaped circumference of shaft 917. When shaft 917 and opening 1014 are engaged, the rotational orientation of the decoy holder with respect to the base is fixed. That is, the decoy holder is not free to rotate. However, the rotational orientation of the decoy holder with respect to the base can be adjusted by removing shaft 917 from opening 1014, rotating shaft 917 with respect to opening 1014 and reinserting shaft 917 into opening 1014.

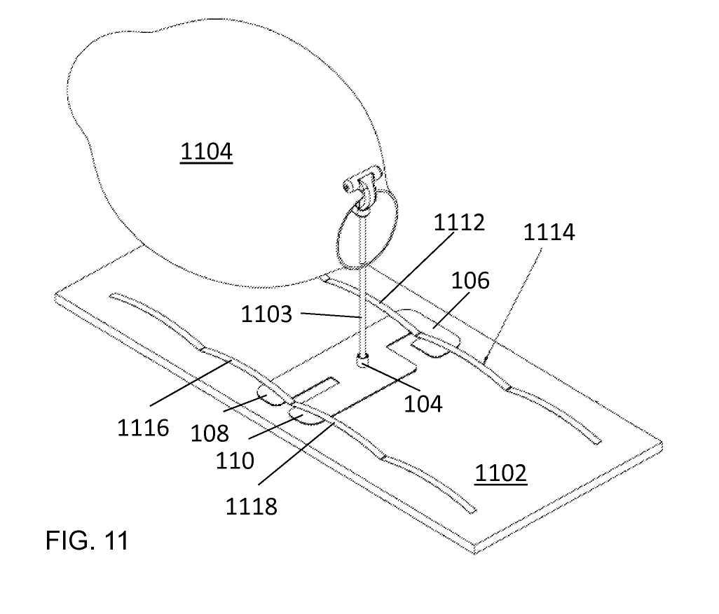

A schematic diagram showing a perspective view of a decoy assembly is provided in FIG. 11. This embodiment includes the decoy attachment device of FIG. 1 secured to four stubble straps 1101 on a hunting blind 1102 (for simplicity, only a portion of the hunting blind is shown). As shown here, hook 106 is looped through two neighboring stubble straps 1102, 1104 in an upper row of stubble straps, while prongs 108, 110 each extend under neighboring stubble straps 1106, 1108 on a lower row of stubble straps. The decoy holder portion of the decoy attachment device is secured to a decoy. The decoy comprises a decoy stake 1103, one end of which is inserted into opening 114 of attachment port 104 and the other end of which is attached to the body of the decoy 1104. For illustrative purposes, the decoy depicted in this embodiment is a windsock type decoy comprising an air bladder body.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, the use of “and” or “or” is intended to include “and/or” unless specifically indicated otherwise.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A decoy attachment device comprising a base configured to secure to a hunting blind or ghillie blanket and a decoy holder attached to the base and configured to secure a decoy to the decoy attachment device.

2. The decoy attachment device of claim 1, wherein the base is configured to secure to at least one strap on the hunting blind or ghillie blanket.

3. The device of claim 2, wherein the at least one strap is a stubble strap on a hunting blind or ghillie blanket.

4. The device of claim 1, wherein the decoy holder is configured to secure a windsock decoy stake to the decoy attachment device.

5. The device of claim 3, wherein the base comprises a plate and the decoy holder is attached to the plate.

6. The device of claim 1, wherein the base comprises a plate and the decoy holder is configured to be attached to the plate in two or more different fixed rotational orientations.

7. The device of claim 1, wherein the decoy holder is configured to secure a decoy in two or more different fixed angular orientations with respect to the base.

8. The device of claim 7, wherein the decoy holder comprises a convex arcuate track comprising two or more decoy securement locations.

9. The device of claim 8, wherein the securement locations comprise openings configured to engage with a decoy stake.

10. The device of claim 7, wherein the decoy holder comprises a joint configured to pivot vertically.

11. The device of claim 6, wherein the decoy holder is configured to secure a decoy in two or more different fixed angular orientations with respect to the base.

12. The device of claim 1, wherein the base comprises a plate comprising a first prong configured to secure to a first strap on the hunting blind or ghillie blanket and a second prong configured to secure to a second strap on the hunting blind or ghillie blanket.

13. A decoy assembly comprising:
a hunting blind or ghillie blanket;
a decoy attachment device comprising a base permanently or removeably secured to the hunting blind or ghillie blanket and a decoy holder attached to the base; and
a decoy secured to the decoy holder.

14. The assembly of claim 13, wherein the hunting blind or ghillie blanket comprises at least one strap and the decoy attachment device is removeably secured to the at least one strap.

15. The assembly of claim 14, wherein the strap is a stubble strap on a layout blind.

16. The assembly of claim 13, wherein the decoy is a windsock decoy comprising air bladder mounted to a stake, and further wherein the stake is secured to the decoy holder.

17. The assembly of claim 13, wherein the base comprises a plate and the decoy holder is configured to be attached to the plate in two or more different fixed rotational orientations.

18. The assembly of claim 13, wherein the decoy holder is configured to secure the decoy in two or more different fixed angular orientations with respect to the base.

19. The assembly of claim 18, wherein decoy holder comprises a convex arcuate track comprising two or more decoy securement locations.

20. The assembly of claim 17, wherein the decoy holder comprises a joint configured to pivot vertically.
